(19) United States
(12) Patent Application Publication
(10) Pub. No.: US 2009/0097473 A1
(43) Pub. Date: Apr. 16, 2009

(54) Functional extended system of network communication device and its method

(75) Inventors: Chen-Chi Shih, Taipei (TW); Chang-Hung Yu, Taipei (TW)

Correspondence Address: EDWARDS ANGELL PALMER & DODGE LLP, P.O. BOX 55874, BOSTON, MA, 02205, US

(73) Assignee: Inventec Multimedia & Telecom Corporation, Taipei (TW)

(21) Appl. No.: 11/974,471

(22) Filed: Oct. 11, 2007

(51) Int. Cl. H04L 12/66

(52) U.S. Cl. 370/352

(57) ABSTRACT

A functional extended system of network communication device and its method are disclosed according to the present invention. The functional extended system of network communication device and its method are applicable to a network communication function extended equipment that is connecting to a network communication device that has universal communication transmit port, mainly it connects to the universal communication transmit port of the network communication device via an extended communication transmit port, and it also has its data processing unit and the network communication device produce a handshake based on a preset communication protocol, and then it has the data processing unit execute data process that includes at least encoding/decoding data transmitted from/to the network communication device based on the preset communication protocol, thus the data processing unit is able to drive corresponding functional extended module to execute extending function, and/or it can further connect with other functional extended system of network communication device, therefore, the network communication device is capable of extending continually.

### BACKGROUND OF THE INVENTION

1. Field of the Invention

This invention generally relates to a network communication device technique, and more specifically, to a functional extended system and its method that is applicable to network communication devices.

2. Description of Related Art

Telephones and facsimiles took a major role in the earlier stage of communication system, and the telephone exchangers were the core of the telephones system. Nowadays, since information based technology and computer technology are getting popular at a fast pace, via a network environment of exclusive data communication, application programs in computers such as emails, instant messages, ERP system, and others, can be shared conveniently and efficiently.

And along with the continual productions of new editions of message format, the traditional communications network structure faces challenges, for instance, if a telephones system adds in a voice mail service, its telephone exchanger has to be connected to a computer server that provides voice mail box storage function via digital line. Cases like the aforementioned add-in to a traditional communication structure will have network structure be getting complicated, thus the cost of equipments and management will get higher, while the efficiency and safety decrease dramatically.

Internet began to develop vigorously in 1990, and internet protocol (IP) has become the mainstream standard of network world since then, besides the most popular World Wide Web (WWW) service, people have been thinking of taking advantages of IP in applications of other communications means. Although quality of voice transmitted via internet was not ideal in the early stage, network bandwidth has kept expanding as well as data compression technique is getting improved, and when Voice over IP (VoIP) becomes pure data transmission, VoIP, then, becomes another important internet service.

The main purpose for users to adopt VoIP is to decrease operational cost and increase industrial communication power. By replacing public switched telephone network (PSTN) with VoIP based IP telephone system, voice transmission cost can be decreased dramatically, besides, IP communications technology is capable of integrating traditional telephones network and information network into an IP communications network, thus industries can benefit from line cost reinvestment and cutting on network equipments and maintenance manpower.

The prior IP telephones system is making use of present Internet Protocol (IP) to transmit voice information via network. An IP telephone includes conversion gateway of traditional telephones system, support of analog telephones, Digital Signal Processor (DSP), and voice gateway, and a general IP telephone is an user end equipment, IP telephone can be easily connected to network structures such as Ethernet and others, and thus provides all the functions of a traditional analog telephone as well as more sophisticated communication services, such as browsing WWW, receiving emails, etc.

Although IP telephone provides more functions than traditional telephone, compared with software IP telephone that processes network communications via data processing devices such as personal computer and others, single-machine IP telephone has obviously less functions. To solve this disadvantage, IP telephones developers provide many functional extended modules for users to connect to IP telephones and other network communication devices, thus to provide the network communication devices with more extended functions.

However, according to the aforementioned prior functional extension technique of network communication device, developers design and manufacture extension interface and supportive functional extended module based on the specification of each different network communication device or supportive functional extended module defined by its own developer, for those network communication devices and functional extended modules of incompatible specification, the compatibility is relatively low, thus users have less choices of functional extended modules. In addition, to develop an extra specification and then design an expansion interface to fit the extra specification will lead to higher manufacturer expenses.

In summary, it is a highly urgent issue in the industry for how to provide a communication transmit port which can make use of present universal communication transmit specification, thus to connect network communication device to network communication function extended equipment and process data transmission, thereby providing the network communication device with a practical functional extension technique.

### SUMMARY OF THE INVENTION

In view of the disadvantages of the prior art mentioned above, it is a primary objective of the present invention to provide a communication transmit port that is able to make use of present universal communication transmit specification, the communication transmit port is for connecting a network communication device to a network communication function extended equipment and then processing data transmission, thereby providing the network communication device with functional extended system of network communication device and its method to extend functions.

To achieve the aforementioned and other objectives, a functional extended system of network communication device and its method is provided according to the present invention. The functional extended system of network communication device is applicable to a network communication function extended equipment that has functional extended module and is connecting to a network communication device that has universal communication transmit port, the functional extended system of network communication device of the present invention comprises: at least one extended communication transmit port, which has same data transmission specification as the universal communication transit port and is for connecting to the universal communication transit port of the network communication device; a data processing unit, which is for controlling the functional extended module and also for processing data including at least commands from the network communication device transmitted via the universal communication transmit port and the extended communication transmit port.

In one embodiment according to the present invention, the functional extended system of network communication device of the present invention further comprises a display unit that is for receiving drive from the data processing unit and then correspondingly displaying messages of data processed by the data processing unit.

In another embodiment according to the present invention, the functional extended system of network communication device of the present invention further comprises at least one first fix part and at least one fixing element, and the network communication device further comprises at least one second fix part, wherein, the fixing element is fixed to the first fix part and the second fix part, thus to have the network communication function extended equipment and the network communication device be connected to each other.

In one further embodiment according to the present invention, the specification of the universal communication transmit port and the extended communication transmit port is the same as of an RJ11, an USB, or an IEEE1394.

The present invention further discloses a functional extension method that is executed in the aforementioned functional extended system of network communication device of the present invention, the functional extension method of network communication device of the present invention comprises: have the extended communication transmit port and the universal communication transmit port connect to each other; have the data processing unit and the network communication device produce a handshake based on a preset communication protocol; have the data processing unit execute data process including at least enencoding/decoding of data transmitted from/to the network communication device based on the preset communication protocol; and have the data processing unit drive the corresponding functional extended module to execute functional extension process.

In one embodiment according to the present invention, the functional extension method of network communication device of the present invention further comprises: provide a display unit, and have the display unit receive drive from the data processing unit and then correspondingly display messages of data processed by the data processing unit.

In one further embodiment according to the present invention, the specification of the universal communication transmit port and the extended communication transmit port is the same as of an RJ11, an USB, or an IEEE 1394.

Compared with the prior functional extension technique of network communication device, the functional extended system of network communication device and its method of the present invention, by means of connecting the aforementioned universal communication transmit port of network communication device with the extended communication transmit port of the network communication function extended equipment, and also by having the data processing unit process commands transmitted from the network communication device and control the functional extended module, it is able to make use of communication transmit ports of present universal communication transmit specification, there is no needs of a particular communication transmit specification and the network communication device can connect and work with network communication function extended equipment, thus fulfills the goal of providing the network communication device with capability of extending its functions.

### BRIEF DESCRIPTION OF DRAWINGS

The present invention can be more fully understood by reading the following detailed description of the preferred embodiments, with reference made to the accompanying drawings, wherein:

FIG. 1 is an applied framework diagram illustrating a functional extended system of network communication device according to the present invention;

FIG. 2 is a flowchart diagram that illustrates procedure of functional extension method of network communication device of the present invention executed in the aforementioned functional extended system of network communication device of the present invention;

FIG. 3 is a diagram that illustrates how a network communication function extended equipment and a network communication device connect to each other according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

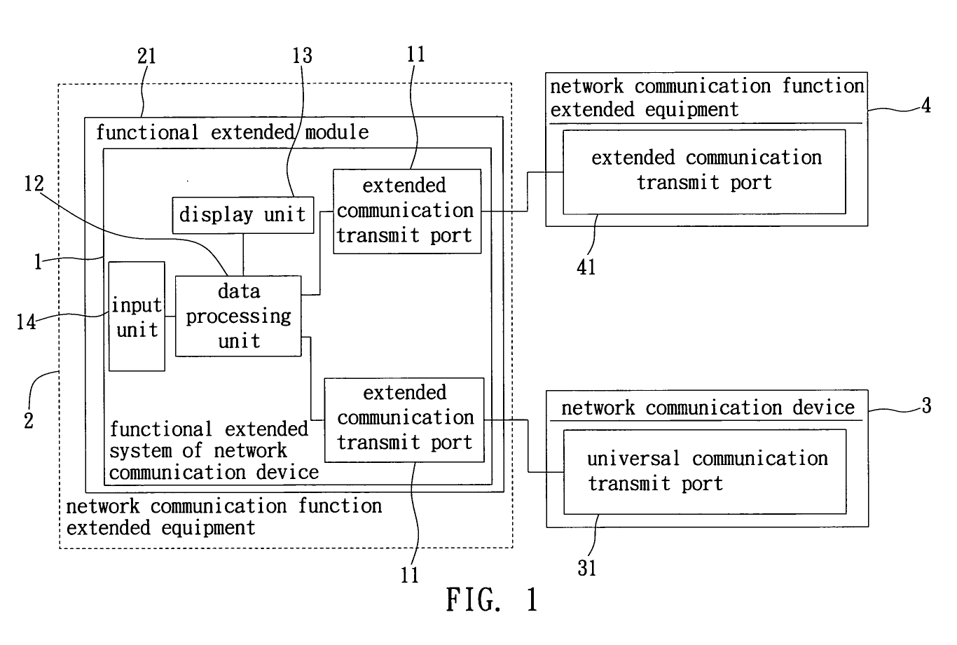

Please refer to FIG. 1, which is an applied framework diagram that illustrates a functional extended system of network communication device according to the present invention. As shown in FIG. 1, the functional extended system of network communication device of the present invention 1 is applicable to a network communication function extended equipment 2, the network communication function extended equipment 2 has a functional extended module 21, and the network communication function extended equipment 2 is connecting to a network communication device 3, the network communication device has universal communication transmit port 31.

In the present embodiment, the network communication device 3 is an IP telephone, the universal communication transmit port 31 is a communication transmit port of RJ11 specification, the network communication function extended equipment 2 is the functional extended module 21 that supports the network communication device 3 and provides a plurality of input units. In other embodiments of the present invention, the network communication device 3 can be other device that is capable of connecting to and communicating with other networks, the specification of the universal communication transmit port 31 can also be the same as of an universal serial bus (USB) or an IEEE1394, the network communication function extended equipment 2 can be, for example, video functional extended module, audio functional extended module, and/or video and/or audio data storage functional extended module. In other embodiments of the present invention, the universal communication transmit port 31 can be plural based on the situation of need.

As shown in the figure, the functional extended system of network communication device 1 of the present invention comprises: extended communication transmit port 11, data processing unit 12, display unit 13, and input unit 14.

The extended communication transmit port 11 has the same data transmission specification as the universal communication transmit port 31 and is for connecting to the universal communication transmit port 31 of the network communication device 3. According to the stated aforesaid, the universal communication transmit port 31 is a communication transmit port of RJ11 specification, thus the extended communication transmit port 11 is also a communication transmit port of RJ11 specification. In the present embodiment, the functional extended system of network communication device 1 of the present invention has two extended communication transmit ports 11, one of the extended communication transmit ports 11 is for connecting with the universal communication transmit port 31, and the other extended communication transmit port 11 is for connecting to an extended communication transmit port 41 of another network communication function extended equipment 4, in the same manner, the other extended communication transmit port 11 also can be for connecting to other network communication device. It should be noted especially hereby that the other network communication device and/or network communication function extended equipment that connect to the other extended communication transmit port 11 should have communication transmit port of the same data transmission specification as the other extended communication transmit port 11. In other embodiments of the present invention, the number of the extended communication transmit port can be adjusted based on the situation of need.

It should also be noted especially hereby that, in the present embodiment, the data transmission specification of the extended communication transmit port 11 and the universal communication transmit port 31 can be, for example, Session Initiative Protocol (SIP) provided for IP network by standard call process functions and traits of public switched telephone network (PSTN). The data processing unit 12 is for processing data including at least commands transmitted from network communication device 3 via the universal communication transmit port 31 and the extended communication transmit port 11 as well as for controlling the functional extended module 21. In the present embodiment, the data processing unit 12 is a microprocessing unit, in other embodiments of the present invention, the data processing unit 12 can also be a central processing unit or any other chip that has data processing functions. In the present embodiment, the data processing unit 12 can be an, e.g. C8051 model or other compatible data processing unit.

The display unit 13 is for receiving drive from the data processing unit 12 and then correspondingly displaying message of data processed by the data processing unit 12. In the present embodiment, the display unit is a liquid crystal display (LCD) unit that is for displaying messages of commands, prompts of operational process, or others received by the data processing unit 12 from the network communication device 3 transmitted via the universal communication transmit port 31. In other embodiments of the present invention, the display unit 13 can also be a device of at least one light emitting diode (LED).

The input unit 14 is a plurality of direct dialing/function keys located on the network communication function extended equipment 2.

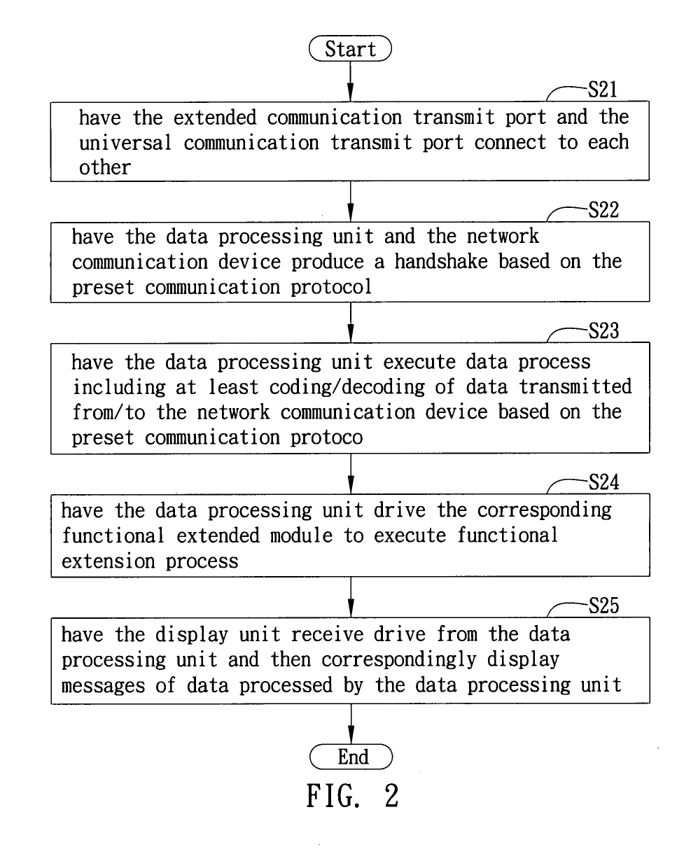

Please refer to FIG. 2, which is a flowchart diagram that illustrates procedure of functional extension method of network communication device of the present invention executed in the aforementioned functional extended system of network communication device of the present invention. In step S21, have the extended communication transmit port and the universal communication transmit port connect to each other. Proceed to step S22.

In step S22, have the data processing unit and the network communication device produce a handshake based on the preset communication protocol. Proceed to step S23.

In step S23, have the data processing unit execute data process including at least encoding/decoding of data transmitted from/to the network communication device based on the preset communication protocol. Proceed to step S24.

In step S24, have the data processing unit drive the corresponding functional extended module to execute functional extension process. Proceed to step S25.

In step 25, have the display unit receive drive from the data processing unit and then correspondingly display messages of data processed by the data processing unit.

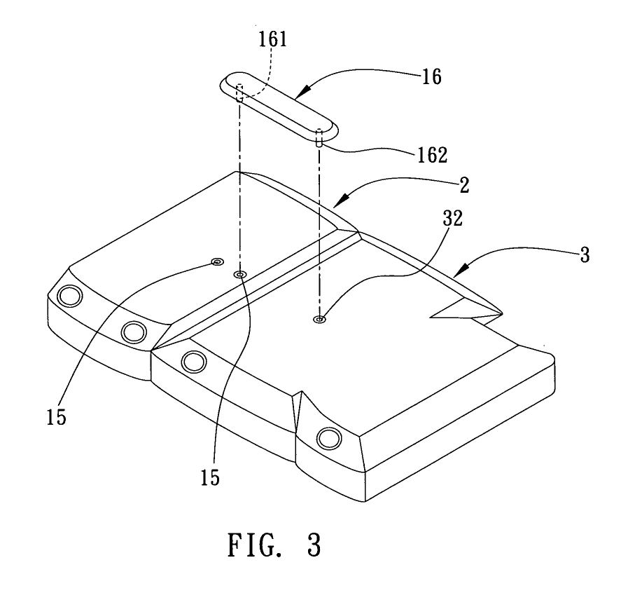

Please refer to FIG. 3, which is a diagram that illustrates how a network communication function extended equipment and a network communication device connect to each other according to the present invention. As shown in the figure, the functional extended system of network communication device 1 of the present invention further comprises two first fix parts 15 and one fixing element 16, and the network communication device 3 further comprises one second fix part 32, in the present embodiment, the fixing element 16 has two raised parts 161 and 162 located on two ends of its one surface and respectively corresponding to the first fix part 15 and the second fix part 32, the first fix part 15 and the second fix part 32 are complementary parts to the raised parts 161 and 162, size of the raised parts 161 and 162 of the fixing element 16 is equal to or a little bit bigger than the size of the complementary parts of the first fix part 15 and the second fix part 32, thus when the raised parts 161 and 162 respectively insert into corresponding first fix part 15 and second fix part 32, the network communication function extended equipment 2 and the network communication device 3 can be securely connected to each other. It should be noted hereby that the number of each of the first fix part, the second fix part, and the fixing element can be adjusted based on the situation of need.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A functional extended system of network communication device, which is applicable to a network communication function extended equipment that has functional extended module and is connecting to a network communication device that has universal communication transmit port, the functional extended system of network communication device comprises:
at least one extended communication transmit port, which has same specification as the universal communication transmit port and is for connecting to the universal communication transmit port of the network communication device; and
a data processing unit, which is for processing data including at least commands of the network communication device transmitted via the universal communication transmit port and the extended communication transmit port, the data processing unit is also for controlling the functional extended module.

2. The functional extended system of network communication device of claim 1, wherein, further comprises at least one first fix part and at least one fixing element, and the network communication device further comprises at least one second fix part, and then the fixing element is fixed to the first fix part and the second fix part.

3. The functional extended system of network communication device of claim 1, wherein, further comprises a display unit that is for receiving drive from the data processing unit and correspondingly display messages of data processed by the data processing unit.

4. The functional extended system of network communication device of claim 3, wherein, the display unit is either a liquid crystal display unit or a light emitting diode device.

5. The functional extended system of network communication device of claim 1, wherein, the network communication device is an IP telephone.

6. The functional extended system of network communication device of claim 1, wherein, comprises two extended communication transmit ports, one of the extended communication transmit ports is for connecting to the universal communication transmit port, the other extended communication transmit port is for connecting to either other network communication function extended equipment or other network communication device.

7. The functional extended system of network communication device of claim 1, wherein, the data processing unit is either a microprocessing unit or a central processing unit.

8. The functional extended system of network communication device of claim 1, wherein, the specification of the universal communication transmit port and the extended communication transmit port is the same as of an RJ11, an universal serial bus (USB), or an IEEE1394.

9. The functional extended system of network communication device of claim 1, wherein, the data transmission specification of the extended communication transmit port and the universal communication transmit port is the same as of Session Initiative Protocol (SIP).

10. The functional extended system of network communication device of claim 1, wherein, the data processing unit is an C8051 chip.

11. A functional extension method of network communication device, which is applicable to a network communication function extended equipment that has functional extended module and is connecting to a network communication device that has universal communication transmit port, the functional extended system of network communication device comprises: at least one extended communication transmit port, which has the same data transmission specification as the universal communication transmit port and is for connecting to the universal communication transmit port of the network communication device; and a data processing unit, which is for processing data including at least commands of the network communication device transmitted via the universal communication transmit port and the extended communication transmit port and is also for controlling the functional extended module, the functional extension method of network communication device comprises the following steps:
have the extended communication transmit port and the universal communication transmit port connect to each other;
have the data processing unit and the network communication device produce a handshake based on a preset communication protocol;
have the data processing unit execute data processes including at least encoding/decoding of data transmitted from/to the network communication device based on the preset communication protocol;
have the data processing unit drive the corresponding functional extended module to execute functional extension process.

12. The functional extension method of network communication device of claim 11, wherein, further comprises the following steps: provide a display unit, and have the display unit receive drive from the data processing unit and then correspondingly display messages of data processed by the data processing unit.

13. The functional extension method of network communication device of claim 12, wherein, the display unit is either a liquid crystal display unit or a light emitting diode device.

14. The functional extension method of network communication device of claim 11, wherein, the network communication device is an IP telephone.

15. The functional extension method of network communication device of claim 11, wherein, the data processing unit is either a microprocessing unit or a central processing unit.

16. The functional extension method of network communication device of claim 11, wherein, the specification of the universal communication transmit port and the extended communication transmit port is the same as of an RJ11, an universal serial bus (USB), or an IEEE1394.

17. The functional extension method of network communication device of claim 11, wherein, the data transmission specification of the extended communication transmit port and the universal communication transmit port is the same as of Session Initiative Protocol (SIP).

18. The functional extension method of network communication device of claim 11, wherein, the data processing unit is an C8051 chip.
